(19) United States
(12) Patent Application Publication
(10) Pub. No.: US 2008/0181653 A1
(43) Pub. Date: Jul. 31, 2008

(54) INTEGRATED SYSTEM FOR MANAGING PRODUCTION OF REMOTE PRINTING AND OTHER INFORMATION DISTRIBUTION TASKS

(76) Inventors: Keith Elzia, Eden Prairie, MN (US); Mark Larson, Lino Lakes, MN (US); Mills Davis, Washington, DC (US); Alfred Brown, Las Vegas, NV (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 12/058,281

(22) Filed: Mar. 28, 2008

Related U.S. Application Data
(63) Continuation-in-part of application No. 11/857,965, filed on Sep. 19, 2007.
(60) Provisional application No. 60/845,643, filed on Sep. 19, 2006.

(51) Int. Cl. G03G 15/00

(52) U.S. Cl. 399/83

(57) ABSTRACT

A system assigns a plurality of printing or other information distribution jobs to a plurality of medium units for processing. The system includes an input interface module receiving from customers, specification data files each specifying an information display job in a specification file signal. The input interface module selects for each specification data file at least one medium unit suitable for performing the information display job in the specification data file and forms for each specification file signal, a job description format (JDF) file recording the information in the specification data file and the identifier of each selected medium unit. The input interface module provides the JDF file in a JDF file signal. An application interface module receives each JDF file signal, and deletes all but one of the at least one medium unit identifiers specified in the JDF file, and provides a modified JDF file signal based on the JDF file signal. A job aggregation module within the application interface module receives each modified JDF file signal and transmits the data content therein to the medium unit specified in the modified JDF file signal.

### CROSS-REFERENCE TO RELATED APPLICATIONS

This is a continuation-in-part application filed under 35 U.S.C. § 111(a) claiming priority, under 35 U.S.C. § 119(e)( 1), of provisional application Ser. No. 60/845,643, previously filed Sep. 19, 2006 under 35 U.S.C. § 111(b), and of regular application Ser. No. 11/857,965 filed on Sep. 19, 2007. Abandon said prior application after according its filing date to this application.

### BACKGROUND OF THE INVENTION

This invention pertains to a computer-based integrated system for controlling printing jobs and printers, as well as other types of apparatus for providing information for human viewing or hearing. The term “medium unit” refers to any type of device capable of providing information in human-understandable form. One common type of medium unit is a printer, but computer-controlled billboard displays and sound generators are among other devices that may form a medium unit. For this description, each medium unit has an identifier by which the unit is identified and by which information may be sent to the unit.

An important purpose of the invention is to manage use of printers in an environment where many different print jobs are active at any time, and to assist in allocating or assigning the jobs to the most suitable printer. However, the invention can also control allocation of jobs to other types of devices.

The term “document” refers to the output of a medium unit, and for purposes of this specification, includes not only printed matter, but also information provided by for example, a display unit or a loudspeaker.

Turning first to FIG. 1, those familiar with computer-based systems understand that a computer comprises an instruction processor 4 and at least one memory unit 5. Processor has a signal path 6 by which processor 4 communicates with external devices.

A memory unit 5 comprises individual memory locations, each of which can be accessed in some way by processor 4 on a path 7 to store into and retrieve from, data elements stored in the memory locations. Individual memory locations record data comprising one or more binary digits (bits). This data is of two general types. One type is computer instructions. The instruction processor 4 retrieves and executes instructions stored in the memory unit 5.

The second general type of data recorded in memory locations is that processed by instruction execution, which data will be referred to as operands. Such execution causes changes according to the definition of the instruction, in operands stored in memory locations the executed instruction specifies. So, for example, executing an ADD instruction might cause the instruction processor 4 to add the contents of one memory location (the first operand) to the contents of another memory location (the second operand).

Often, but not always, a single physical memory unit 5 functions as both the data memory and the instruction memory. For example, it is common to store on a floppy disk or a CD, data generated by instruction execution, but to store instructions only in the computer's hard drive, and during execution, in the random access memory (RAM).

Executing individual instructions causes the processor 4 to request operands from specified individual memory locations in the memory unit 5 that present as output signals from the memory unit 5 carried on data path 7, and to generate input signals to the memory unit 5 comprising operands that overwrite the contents of individual memory locations specified in the input signal on data path 7.

A program or application comprises a number of instructions whose execution controls operation of the computer. The terms “program” and “application” are interchangeable in common terminology. Everyone is familiar with applications such as Outlook, Word, Turbotax, etc. A typical application comprises many, perhaps millions of individual instructions. Each application has many individual functions that cooperate to provide the application's overall functionality

One or more related instructions define a particular function that forms a part of the application the processor 4 is executing. As the processor 4 executes a set of related instructions, the processor functions as a functional block element defined by the instructions. The individual instructions thus define the individual functional block element.

Therefore, one can consider an application during execution within a computer as sequentially comprising individual functional block elements, each of these elements physically comprising the processor 4 along with the instructions stored in memory unit 5 that define that functional block element. Each of these functional block elements receives operands in output signals from the memory unit 5 on data path 7 and transmits operands in input signals to the memory 5 on data path 7.

Of course, each functional block element is usually different from every other functional block element. That is, the computer literally and physically becomes first one, then another of these functional block elements. The computer may become a particular functional block element many times in the course of executing an application.

Each instruction and each operand when stored in memory unit 5 causes a physical change in that memory unit 5. The change typically occurs at a sub-microscopic level, but nonetheless is real (tangible) although difficult or impossible for a human to view directly. But the presence of these changes is inferable by reading data from a particular memory location before and after an operand is stored in it. These individual functional block elements thus cause actual changes in the physical structure of the memory unit 5 recording the operands.

A problem that exists in the printing and other information distribution industries, is that of efficiently assigning individual tasks to the medium units that perform the tasks. Such devices are expensive, so the ability to keep them busy nearly all the time reduces overall costs. To date, the inventors are not aware of a system for allocating jobs to individual medium units so that the most suitable medium units are used as heavily as possible.

### BRIEF DESCRIPTION OF THE INVENTION

A system comprises a computer having a memory unit storing data and instructions and a processor for executing instructions stored in the memory unit to thereby alter data stored in the memory unit. The system distributes a plurality of information display jobs provided by a plurality of customers to a plurality of medium units. An identifier value is associated with each medium unit.

The system includes an input interface module receiving from customers, specification data files each specifying an information display job in a specification file signal. The input interface module selects for each specification data file at least one medium unit suitable for performing the information display job in the specification data file and forms for each specification file signal, a job description format (JDF) file recording the information in the specification data file and the identifier of each selected medium unit. The input interface module provides the JDF file in a JDF file signal.

An application interface module receives each JDF file signal, and deletes all but one of the at least one medium unit identifiers specified in the JDF file, and provides a modified JDF file signal based on the JDF file signal.

A job aggregation module within the application interface module receives each modified JDF file signal and transmits the data content therein to the medium unit specified in the modified JDF file signal.

In one version of the system, the memory unit stores characteristics for a plurality of medium units. The application interface module transmits each modified JDF file signal to a medium unit based on the characteristics of that medium unit and the content of the JDF signal.

Preferably, the application interface module includes a cost estimator module receiving the JDF file signal, and provides a price signal to the customer providing the specification file signal from which application interface element generated the job definition format signal. The medium selection module receives an approval signal from the customer, and transmits the modified JDF signal to a medium unit responsive to the acceptance signal.

The medium selection module may further comprise a job aggregation module receiving a plurality of JDF signals, and responsive to an operator signal, deleting all but one medium unit identifier from the modified JDF file. Each JDF file may includes at least one of a due date, a due time, and in association with each medium unit, a job duration value.

### BRIEF DESCRIPTION OF THE DRAWINGS

FIG. 1 is a block diagram of a typical computer suitable for serving as the platform for the invention.

FIG. 2 is a block diagram of a control system for managing the production of printing and other types of information distribution tasks.

FIG. 3 is a block diagram of an input interface section of the control system.

FIG. 4 is a block diagram of an application interface section of the control system.

### DESCRIPTION OF THE PREFERRED EMBODIMENTS

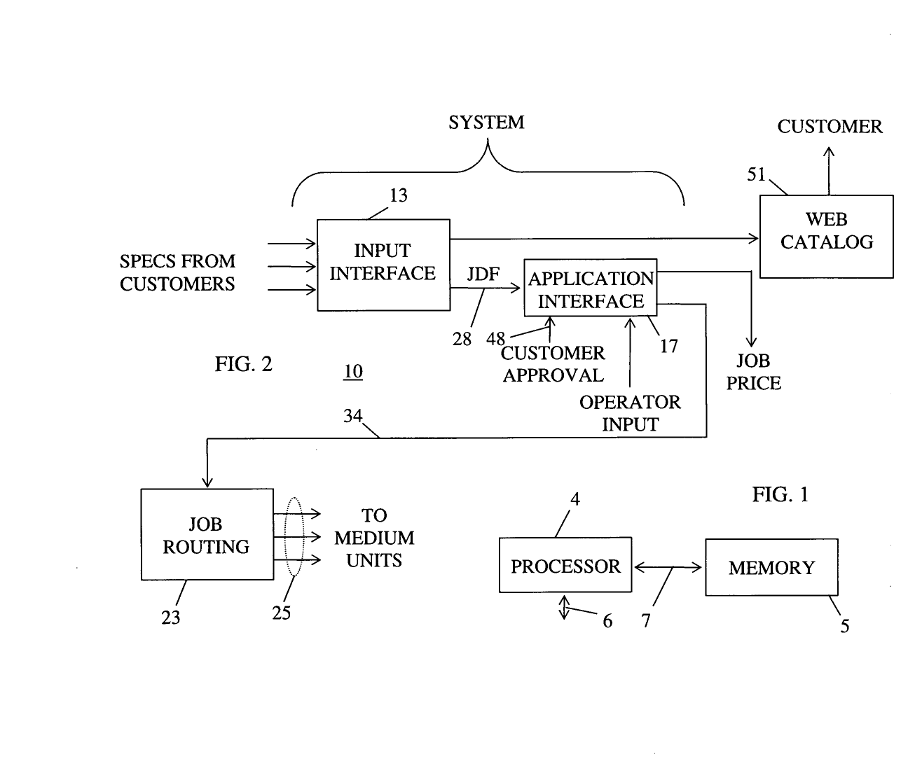

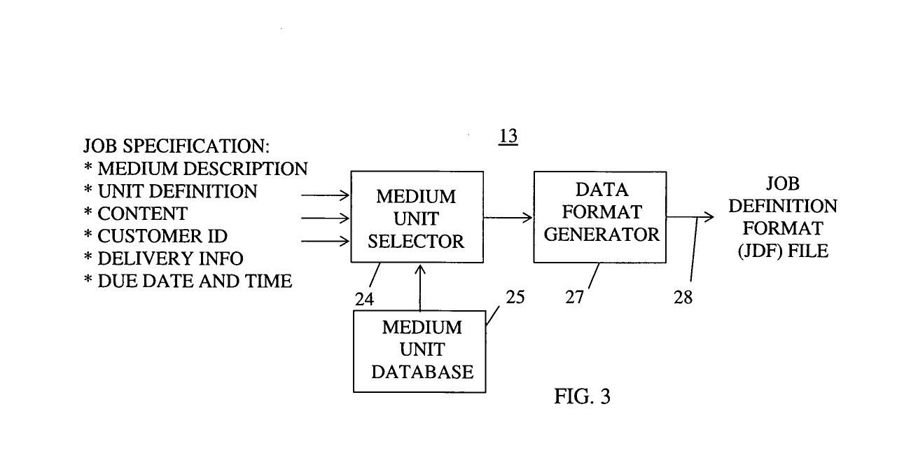

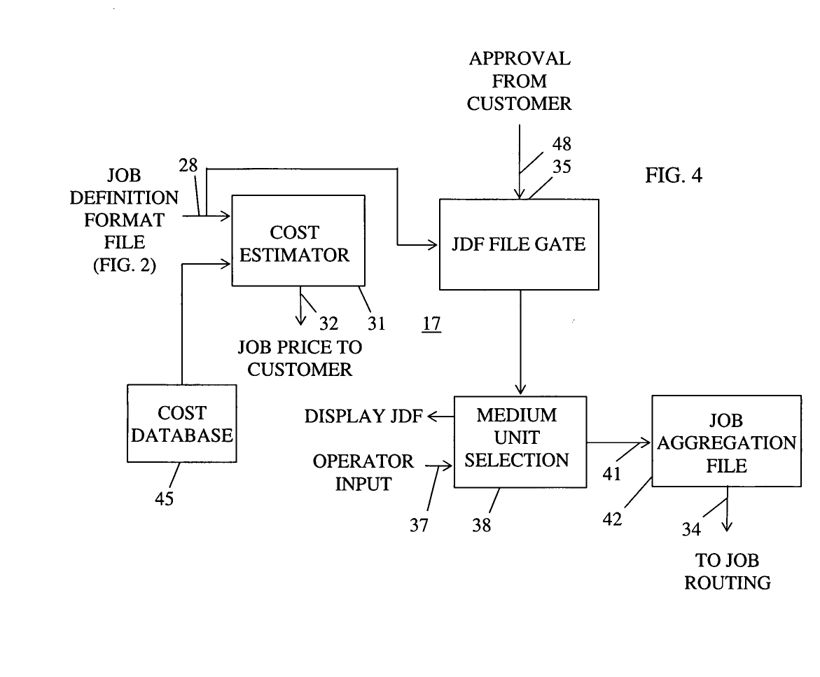

The block diagram in FIG. 2 shows the overall structure of this computer-based system 10 for managing assignment of printing jobs and other types of information distribution activities to medium units. System 10 comprises an input interface module 13, an application interface module 17, and a job routing module 23. As discussed earlier, each of these are physically, a combination of software and hardware. In addition, the input interface module maintains a web catalog 51 for customer use. The media available are most often printers, but may also be other types of information production devices such as loudspeakers for elevator advertising, or electronic billboards.

A plurality of customers, typically using the Internet, each provides to the input interface module 13 in the form of a specification data file, requests for jobs. Usually, the customer will simply file out a web form to create the specification data file.

Thus, if the job is a print job, the specification data file completely defines the finished document: text and images including colors; layout; paper size and weight; number of copies; customer ID; shipping information; and due date. Requests for jobs requiring other types of medium units will have other information suited to the type of job.

The input interface module 13 converts the specification file into a “job definition format” (JDF) file that includes all of the information in the specification data file. Module 13 sends the JDF file to the application interface module 17 on a path 28. FIG. 2 shows the input interface module 13 in more detail.

The application interface unit 17 receives each JDF file on path 28 from the input interface unit 13, and uses the JDF file to generate a price signal to the customer specifying the price of the job defined by the JDF file. The price signal includes an opportunity for the customer to accept or reject the offer with an approval signal on path 48.

The application interface unit 17 receives inputs from an operator to review the JDF file and override if necessary, a preliminary recommendation of a medium unit by the application interface unit 17. The customer will accept or reject the offer to do a job in the approval signal on path 48 once application interface unit 17 has provided a price signal to the customer. The application interface unit 17 converts the data in the specification data file signal into a JDF file that is stored in the computer memory 5.

Once a customer has accepted a particular price for a job, the application interface unit 17 provides the JDF file to the job routing module 23. The job routing module transmits the JDF file to a selected medium unit for completion.

FIG. 3 shows the input interface module 13 in more detail. Module 13 includes a medium unit selector module 24 that receives the JDF file on path 24, and a medium unit database 25 recorded in the memory 5 that holds the characteristics of all the medium units to which jobs may be assigned. Module 24 uses the database 24 information with the JDF file contents to select one or more available and appropriate medium units for the job defined by the JDF file.

Typically, the various medium units have different characteristics relating to capabilities, speed, availability, cost, geographic location, etc. The medium units also have associated schedules that are used to update database 25. These attributes of the medium units affect which medium units, medium unit selector module 24 selects.

Module 24 transmits the information relating to each job provided in the specification file for that job and the medium unit database 25 to a data format generator module 27. Module 27 generates the JDF file for the job involved using the information received from module 24.

A JDF file typically contains:
MEDIUM DESCRIPTION—type and size of paper, binding instructions, etc.
UNIT IDENTIFIERS—lists by identifier, all medium units suitable for the job.
CONTENT—the actual information to be printed or otherwise displayed.
CUSTOMER ID—the customer identity.
DELIVERY INFORMATION—the location to deliver printed material, the destination of video content, etc.
DUE DATE AND TIME—when delivery to recipient is required, time and duration of video content, etc.
AVAILABLE MEDIUM UNITS—identity of all of the medium units in database 25 that are suitable for performing the job.
JOB DURATION—The estimated time to perform the job on the specified medium unit.
   Module 24 arranges this information into a standardized format and provides the JDF file on path 28.

FIG. 4 shows the application interface module 17 in more detail. A cost estimator module 31 references a cost table database 45 stored in the memory 5 of the computer. Based on the JDF file for a particular job and the database 45 contents, module 31 computes a price for the job and transmits this price in a price signal on path 32 to the customer. Path 32 connects to the customer who submitted the job request, whose ID is in the JDF file for which module 31 has computed the price.

The customer reviews the price in the price signal on path 32 and if acceptable, provides an acceptance code in an approval signal carried on a path 48. The signal on path 48 forms an input to a JDF file gate module 35. Typically, clicking an “accept” button generates the acceptance code in the approval signal.

JDF file gate module 35 receives the acceptance signal and the job definition format file. If the code in the approval signal signifies acceptance, module 35 gates the JDF file on path 28 to a medium unit selection module 38. Module 38 displays the JDF file to the operator. This display includes all of the medium unit options provided by module 24.

The operator selects which of the listed medium units is preferred, and transmits that selection on a medium unit selection signal carried on path 37 to module 38. Module 38 deletes from the JDF file, all except the medium unit identifier specified by the selection signal on path 37, and then transmits the modified JDF file to the job aggregation file module 42 on a path 41. Module 42 records all of the JDF files in a list in memory 5.

Alternatively, each medium unit may provide job queue status to module 38. In that case, module 38 may automatically select the module unit best suited for performing the job. Module 38 may execute an algorithm that combines the due date and time, job duration on each candidate medium unit, and cost to do each job on each medium unit, to select the best medium unit for the job.

In due course, the job aggregation file module 42 transmits each modified JDF file to the medium unit specified by that modified JDF file for production according to the due date and time and the job duration recorded in the modified JDF file. The medium unit receiving the modified JDF file then performs the job and generates a shipping label for it. The intent here is for the term “shipping label” to have a very broad meaning. For example, the shipping label may be an e-mail or automated telephone call that the medium unit generates to inform the customer to pick up the job once completed.

What is claimed is:

1. A system comprising a computer having a memory unit storing data and instructions and a processor for executing instructions stored in the memory unit to thereby alter data stored in the memory unit, said system distributing a plurality of information display jobs provided by a plurality of customers to a plurality of medium units each having an identifier, comprising:
a) an input interface module receiving from customers in specification file signals, specification data files each specifying an information display job, selecting for each specification data file at least one medium unit suitable for performing the information display job in the specification data file, forming a job description format (JDF) file recording the specification data file and the identifier of each selected medium unit, and providing the JDF file in a JDF file signal;
b) an application interface module receiving each JDF file signal, deleting all but one of the at least one medium unit identifiers specified in the JDF file, and providing a modified JDF file signal; and
c) within the application interface module, a job aggregation module receiving each modified JDF file signal and transmitting the data content therein to the medium unit specified in the modified JDF file signal.

2. The system of claim 1, wherein the memory unit stores characteristics for a plurality of medium units, and the application interface module transmits each modified JDF file signal to a medium unit based on the characteristics of that medium unit and the content of the JDF signal.

3. The system of claim 2,
wherein the application interface module includes a cost estimator module receiving the JDF file signal, and providing a price signal to the customer providing the specification file signal from which application interface element generated the job definition format signal;
and including a medium selection module receiving an approval signal from the customer, and transmits the modified JDF signal to a medium unit responsive to the acceptance signal.

4. The system of claim 3, wherein the medium selection module further comprises a job aggregation module receiving a plurality of JDF signals, and responsive to an operator signal, deleting all but one medium unit identifier from the modified JDF file.

5. The system of claim 4, wherein each JDF file includes at least one of a due date, a due time, and in association with each medium unit, a job duration value.
